(19) United States
(12) Patent Application Publication
(10) Pub. No.: US 2006/0098679 A1
(43) Pub. Date: May 11, 2006

(54) Method and apparatus for reducing peak power in code multiplexed downlink control channels

(75) Inventors: Jung-Fu Cheng, Cary, NC (US); Dirk Gerstenberger, Kista (SE); Stefan Parkvall, Stockholm (SE); Andres Reial, Lund (SE); Yi-Pin Eric Wang, Cary, NC (US)

Correspondence Address: COATS & BENNETT, PLLC, P O BOX 5, RALEIGH, NC, 27602, US

(73) Assignee: Telefonaktiebolaget LM Ericsson

(21) Appl. No.: 11/266,522

(22) Filed: Nov. 3, 2005

Related U.S. Application Data
(60) Provisional application No. 60/626,568, filed on Nov. 10, 2004.

(51) Int. Cl. H04B 7/216

(52) U.S. Cl. 370/441

(57) ABSTRACT

A method and apparatus that reduces the likelihood of having a high peak power in any one bit position of code multiplexed downlink control channel symbols is described herein. An exemplary method includes selecting a different bit-level spreading sequence for each mobile terminal from a set of orthogonal bit-level spreading sequences, where code values in any one bit position are not the same for all of the bit-level spreading sequences in the set. When a code multiplexing system uses the selected bit-level spreading sequences from the sequence set to code multiplex the downlink control channel symbols, the resulting combined signal has a lower likelihood of having a high peak power.

This application claims priority from U.S. Provisional Patent Application 60/626,568 filed 10 Nov. 2004, which is incorporated herein by reference.

### BACKGROUND

This invention relates generally to WCDMA code-multiplexed channels, and more particularly to peak power levels in code-multiplexed downlink control channels.

Enhanced Uplink is the next major revision according to the WCDMA (Wideband Code Division Multiple Access) Evolved road map. The main objectives of the Enhanced Uplink are to reduce delays and to improve high-data-rate coverage and capacity for the Enhanced Dedicated Channel (E-DCH). To achieve this, the Enhanced Uplink implements transmission data rate control and physical layer HARQ (Hybrid Auto-Retransmission reQuest) using two downlink control channels, E-RGCH and E-HICH, respectively. The E-HICH (E-DCH HARQ Indicator Channel) is used for signaling “ACK” or “NACK” for the associated HARQ process. The E-RGCH (E-DCH Relative Grant Channel) is used to supply “up” or “down” rate control commands to one or more mobile terminals to control the uplink transmission data rate for the mobile terminals. This rate control helps fine-tune cell-wide uplink interference (also known as uplink noise rise) so that the target cell-wide quality of service, in terms of delays, throughput, and/or call dropping and blockage, can be met. Typically, one E-RGCH message in one transmission time interval (TTI) is used. E-RGCH can also be extended to three-level signaling to support up/down/hold data rate control commands.

The current concept of the Enhanced Uplink simultaneously supports a large number of mobile terminals. As a result, a base station must provide many HARQ control commands and/or rate control commands within a single downlink TTI. Code division multiplexing (CDM) may be employed on the downlink control channels to prevent excessive consumption of OVSF (Orthogonal Variable Spreading Factor) codes by the large number of control commands. Using a CDM approach, a single E-HICH or E-RGCH bit (or ternary symbol) is spread by a bit-level spreading sequence, such as a Hadamard sequence. The spread symbols for all mobile terminals are then combined and the combined signal is spread using a chip-level channelization code, such as an OVSF code. With this approach, the code-sharing E-HICH and E-RGCH signals are mutually orthogonal through the use of the mutually orthogonal bit-level sequences.

Because the CDM approach combines the spread E-HICH/E-RGCH signals, certain circumstances may cause the peak power of the combined signal in one or more bit positions to be high. For example, each spreading sequence in a set of normalized Hadamard sequences has the same code value in the first bit position, i.e., “+1.” If a downlink control channel provides the same command to all or most of the mobile terminals, i.e., a “down” command on the E-RGCH, then the cumulative effect of the individual powers of each spread symbol in the first bit position causes a high peak power in the first bit position of the transmitted control signal.

### SUMMARY

The present invention relates to a method of sending control signals from a base station to a plurality of mobile stations over a common downlink control channel. The control signals for the respective mobile stations are code multiplexed onto the common channel by spreading the individual control signals for the mobile stations with mutually orthogonal bit-level spreading sequences, combining the individual control signals to form a combined signal, and spreading the combined signal with a chip-level channelization code. The set of bit-level spreading sequences is selected to reduce the likelihood of high peak power in the combined signal. Reducing the likelihood of high peak power is achieved by using a set of orthogonal bit-level spreading sequences where the code values are not the same for all spreading sequences at any one bit position. In one exemplary embodiment, the bit-level spreading sequences are derived from a Williamson matrix, which provides the additional benefits of reduced memory requirements and simplified decoding.

### BRIEF DESCRIPTION OF THE DRAWINGS

FIG. 1 illustrates a general block diagram of an exemplary code multiplexing system according to the present invention.

FIG. 2 illustrates a detailed block diagram of an exemplary code multiplexing system according to the present invention.

FIG. 3 illustrates a detailed block diagram of another exemplary code multiplexing system according to the present invention.

FIG. 4 illustrates normalized set of orthogonal bit-level spreading sequences.

FIG. 5 illustrates an exemplary length-20 set of orthogonal bit-level spreading sequences according to an embodiment of the present invention.

FIG. 6 illustrates another exemplary length-20 set of orthogonal bit-level spreading sequences according to an embodiment of the present invention.

FIG. 7 illustrates another exemplary length-20 set of orthogonal bit-level spreading sequences according to an embodiment of the present invention.

FIG. 8 illustrates another exemplary length-20 set of orthogonal bit-level spreading sequences according to an embodiment of the present invention.

FIGS. 9A-9D illustrate another exemplary length-40 set of orthogonal bit-level spreading sequences according to an embodiment of the present invention.

FIGS. 10A-10B illustrate another exemplary length-20 set of complex orthogonal bit-level spreading sequences according to an embodiment of the present invention.

FIG. 11 illustrates a block diagram for an exemplary decoding system according to one embodiment of the present invention.

### DETAILED DESCRIPTION

The Enhanced Uplink in WCDMA (Wideband Code Division Multiple Access) is supported by the E-DCH HARQ Indicator Channel (E-HICH) and the E-DCH Rate Grant Channel (E-RGCH). The E-HICH is a dedicated control channel used to send ACK/NAK bits to a plurality of mobile stations for HARQ operations. The E-RGCH is a dedicated control channel used to send rate control commands to the mobile stations to control the data transmission rates of the mobile stations. Code Division Multiplexing (CDM) is used on the E-HICH and E-RGCH to prevent excessive consumption of chip-level channelization codes, such as OVSF (Orthogonal Variable Spreading Factor) channelization codes.

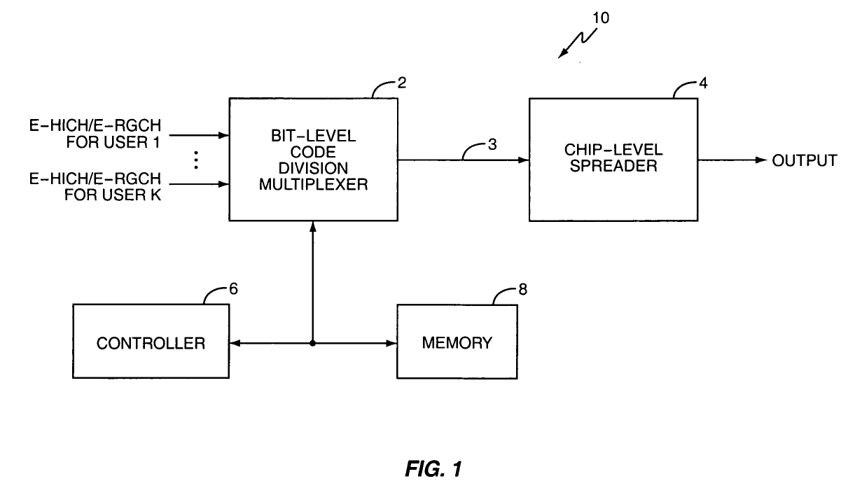

FIG. 1 illustrates an exemplary code-multiplexing system 10 according to the present invention. The exemplary code-multiplexing system 10 includes one or more bit-level code multiplexers 2, one or more chip-level spreaders 4, controller 6, and memory 8. The bit-level code multiplexer 2 spreads E-HICH and/or E-RGCH symbols for multiple users using corresponding bit-level spreading sequences selected by controller 6, and combines the spread symbols to generate a combined signal 3. Subsequently, the chip-level spreader 4 spreads the combined signal 3 using a chip-rate channelization code to generate a code multiplexed E-HICH or E-RGCH signal. Memory 8 stores the bit-level spreading sequences. While FIGS. 1-3 illustrate a CDM system 10 that includes a chip-level spreader 4, those skilled in the art will appreciate that CDM system 10 may be implemented without the chip-level spreader 4.

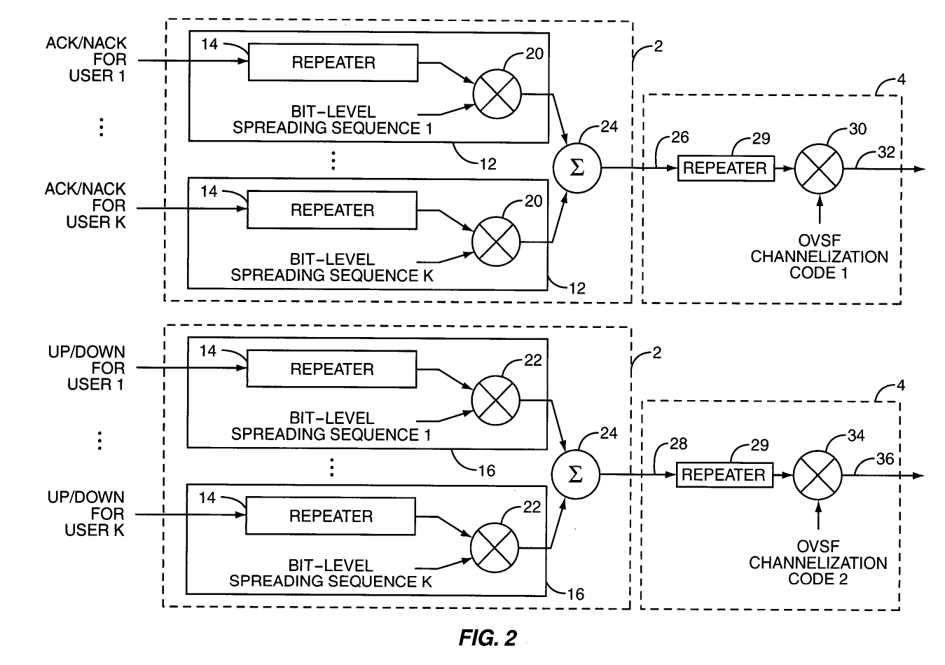

FIG. 2 illustrates additional details of the bit-level code multiplexer 2 and the chip-level spreader 4 of the code multiplexing system 10. FIG. 2 illustrates two bit-level code multiplexers 2 for the E-HICH and E-RGCH, respectively. The bit-level multiplexers 2 comprise a plurality of bit-level spreaders 12,16 and a combiner 24. Input control bits or symbols, such as ACK/NACK symbols or rate control symbols, are input to corresponding spreaders 12, 16. Each spreader 12,16 includes a repeater 14 and multiplier 20, 22. Repeater 14 repeats the input control bit or symbol N times, where N is the bit-level spreading factor. Multiplier 20, 22 outputs the product of the repeated control bit or symbol and the corresponding bit-level spreading sequence selected from a set of orthogonal bit-level spreading sequences by controller 6. Combiner 24 combines the individual spread symbols from each bit-level spreader 12, 16 to generate a combined signal 26, 28. Subsequently, repeater 29 in the chip-level spreaders 4 repeats the combined signals N_{c} times, where N_{c} is the spreading factor of the OVSF channelization codes, and multiplier 30, 34 spreads the combined signal 26, 28 using a single OVSF code to generate a code-multiplexed output signal 32, 36. In an exemplary embodiment, N=20 and N_{c}=128. While not explicitly shown, it will be appreciated that code-multiplexing system 10 may further include a combiner that combines the code-multiplexed output signals 32 and 36 to generate a single output signal for transmission to a remote receiver.

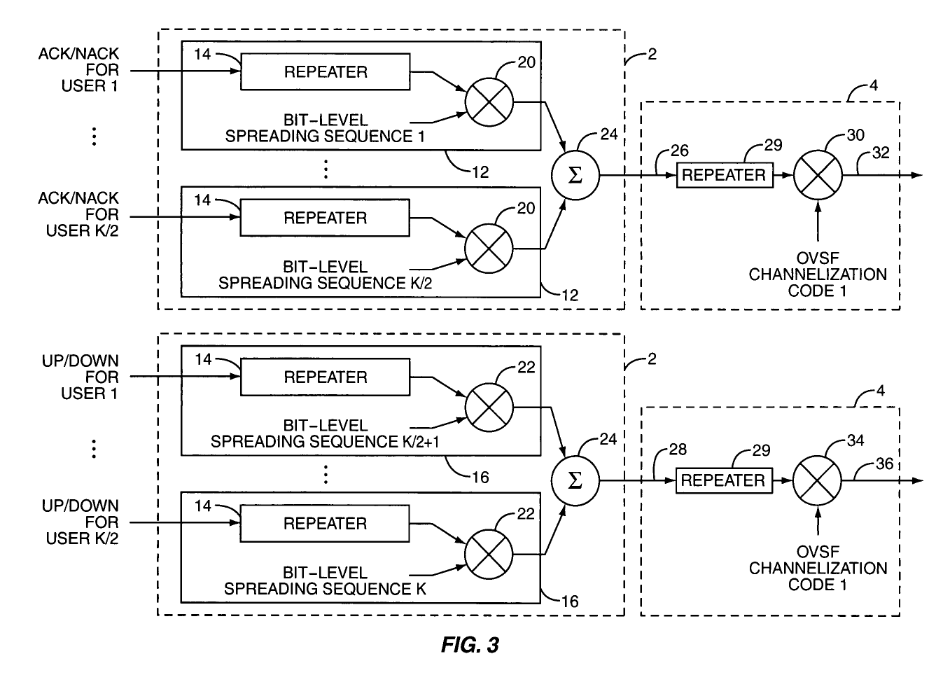

When the code multiplexing system 10 uses different OVSF codes for the E-HICH and the E-RGCH, controller 6 may select the same bit-level spreading sequence for both the E-HICH and the E-RGCH used for a single mobile terminal. In this case, the number of mobile stations that can be supported is equal to the length of the bit-level spreading sequences. Thus, a set of 20 orthogonal bit-level spreading sequences will support 20 different mobile terminals. When the E-HICH and E-RGCH share the same OVSF channelization code, as shown in FIG. 3, the same set of 20 bit-level spreading sequences will support only ten users, since each user will need two spreading sequences.

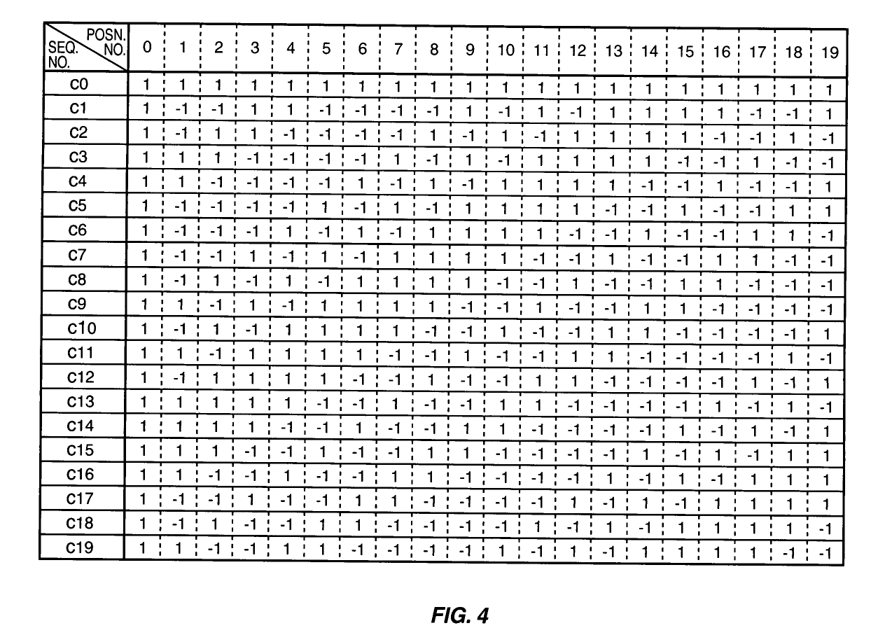

Conventional code multiplexing systems 10 use a normalized set of orthogonal bit-level spreading sequences, such as the normalized set of length-20 Hadamard sequences shown in FIG. 4. The normalized set of spreading sequences has a code value of “1” in the first bit position for all spreading sequences. As a result, when all of the E-HICH symbols carry the same message, i.e., “ACK,” the spread E-HICH symbols accumulate such that the combined signal 26 experiences very high peak power during the first 128 chips (first bit position) of the TTI. Similarly, when all of the E-RGCH symbols carry the same message, i.e., “down,” the spread E-RGCH symbols accumulate such that the combined signal 28 will also experience very high peak power during the first 128 chips (first bit position) of the TTI. If the E-HICH and/or E-RGCH symbols are statistically independent, these events will be relatively rare. However, in practice, such events may occur quite often. For instance, when a base station experiences high noise rise, the base station may need to use the E-RGCH to send a “down” command to each mobile terminal. Furthermore, the HARQ protocol might be designed to use several (or at most one) retransmissions to complete a successful reception of a packet, which would result in the E-HICH messages being mostly NACK (or ACK) symbols.

The present invention reduces the likelihood of experiencing high peak power by spreading the E-HICH and E-RGCH symbols using bit-level spreading sequences selected from a specially configured set of bit-level spreading sequences before applying the common OVSF code. In particular, the sequence set is chosen to prevent any one bit position in the set of sequences from having a large number of “1” or “−1” code values. The sequence set may be evaluated by summing all of the code values in each bit position to generate a “column sum” for each bit position in the sequence set. Because the code values in each bit-level spreading sequence are “+1” or “−1,” the column sum represents a comparison between the number of “+1” code values and the number of “−1” code values in a particular bit position. The sequence set in FIG. 4 has a maximum column sum of 20. The present invention seeks to either reduce the maximum column sum, or to reduce the effect of the maximum column sum, to reduce the likelihood of experiencing a high peak power when transmitting downlink control channel signals.

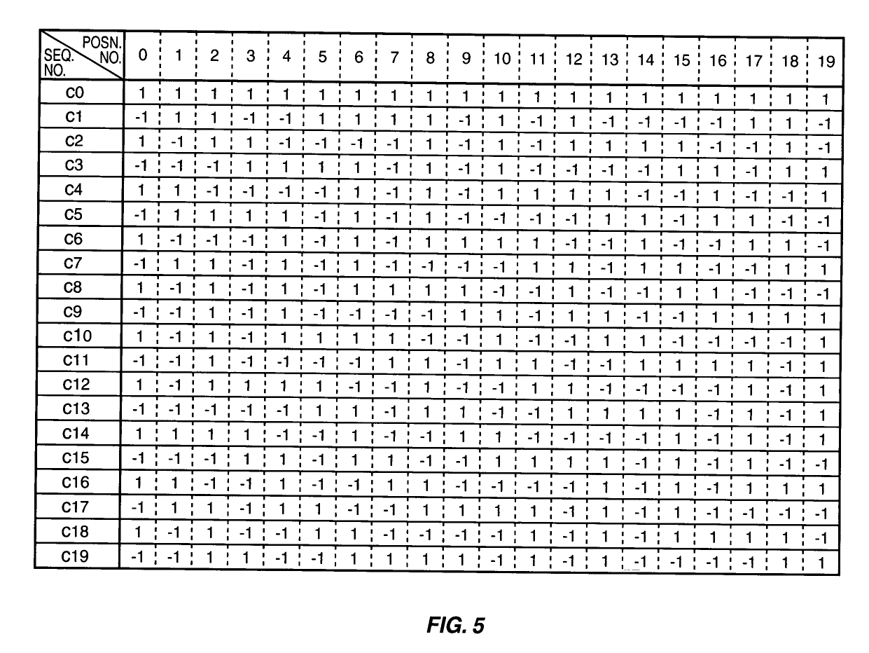

In one exemplary embodiment, the reduced-peak power sequence set may be generated by complementing a subset of a set of the bit-level spreading sequences in the normalized set shown in FIG. 4. For example, complementing the odd-numbered sequences in the normalized set of FIG. 4 generates the sequence set shown in FIG. 5. In this set, the maximum column sum is 8 (bit positions 2, 6, and 8), as opposed to the maximum column sum of 20 (bit position 0) of the normalized set of bit-level spreading sequences shown in FIG. 4. When used to multiplex the E-HICH and/or E-RGCH symbols, the sequence set shown in FIG. 5 reduces the likelihood of having a high peak power associated with the combined signal 26, 28, even when all mobile terminals have the same downlink control channel symbol.

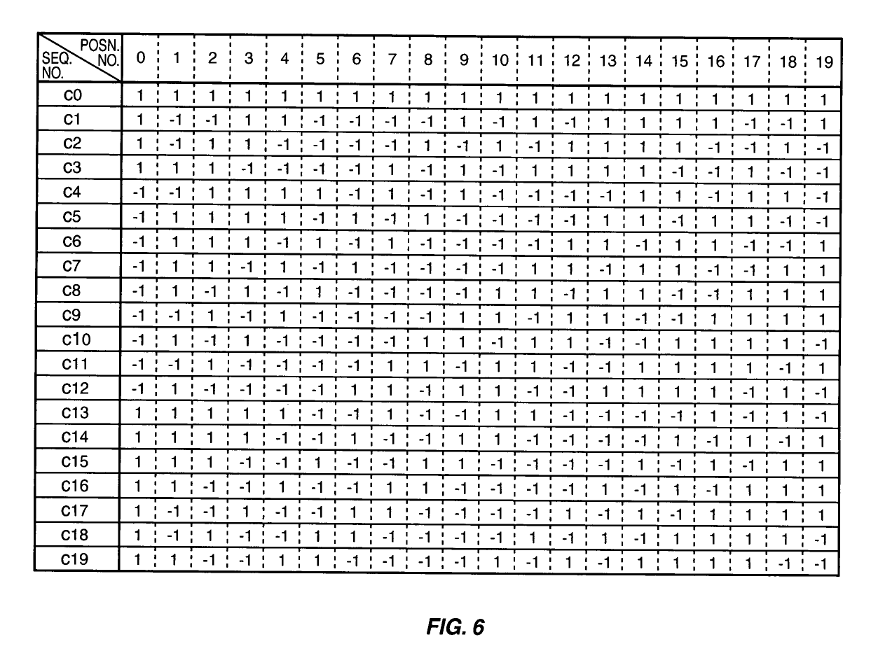

While FIG. 5 illustrates complementing the odd-numbered sequences, it will be appreciated that any subset of the bit-level sequences may be complemented. For example, complementing sequences 4-12 produces the sequence set shown in FIG. 6. This alternative leads to a maximum column sum of 6 (bit positions 1, 2, and 14-18). As will be appreciated by those skilled in the art, other subsets may also be complemented without departing from the scope of the invention.

According to another exemplary embodiment, the sequence set may be based on or derived from a Williamson matrix. Generally, a 4n×4n Williamson matrix may be generated based on four n x n sub-matrices, referred to herein as A, B, C, and D. To generate the Williamson matrix, sub-matrices A, B, C, and D must satisfy the following properties:
1. A, B, C, and D are symmetric and have code values of either +1 or −1.
2. A, B, C, and D commute.
3. A²+B²+C²+D²=4nIₙ, where Iₙ represents an n×n identity matrix.
When A, B, C, and D satisfy these properties, a set of 4n bit-level spreading sequences, each having a length of 4n, may be generated according to:

$$S = [ \begin{matrix}A & B & C & D \\ - B & A & D & - C \\ - C & - D & A & B \\ - D & C & - B & A\end{matrix} ] . \qquad ( 1 )$$

Any set of bit-level spreading sequences generated according to the above-defined procedure produces a set of bit-level spreading sequences that satisfies the requirements of the present invention. In particular, none of the columns in S have all the same code values. As such, when each row of S is used as a bit-level spreading sequence, no one bit position in the set of sequences has an excessively large number of “+1” or “−1” values.

Equation (1) illustrates the general process for generating a 20×20 Williamson matrix. However, to simplify the following discussions, the following examples assume that A=B and that n=5. Assume that a and c represent two length-5 sequences, as shown in Equations (2) and (3).
a=[−1 1 1 1 1] (2)
c=[1 −1 1 1 −1] (3)
Matrices A and C can be generated by cyclically shifting a and c to generate each row as shown below. Matirces A and C are symmetric and commute.

$$A = [ \begin{matrix}- 1 & 1 & 1 & 1 & 1 \\ 1 & - 1 & 1 & 1 & 1 \\ 1 & 1 & - 1 & 1 & 1 \\ 1 & 1 & 1 & - 1 & 1 \\ 1 & 1 & 1 & 1 & - 1\end{matrix} ] C = [ \begin{matrix}1 & - 1 & 1 & 1 & - 1 \\ - 1 & 1 & - 1 & 1 & 1 \\ 1 & - 1 & 1 & - 1 & 1 \\ 1 & 1 & - 1 & 1 & - 1 \\ - 1 & 1 & 1 & - 1 & 1\end{matrix} ]$$

Matrix D may be defined according to Equation (4),
D=2I₅−C, (4)
where I₅ is a 5×5 identity matrix. When A=B, Equation (1) becomes:

$$S = [ \begin{matrix}A & A & C & D \\ - A & A & D & - C \\ - C & - D & A & A \\ - D & C & - A & A\end{matrix} ] . \qquad ( 5 )$$

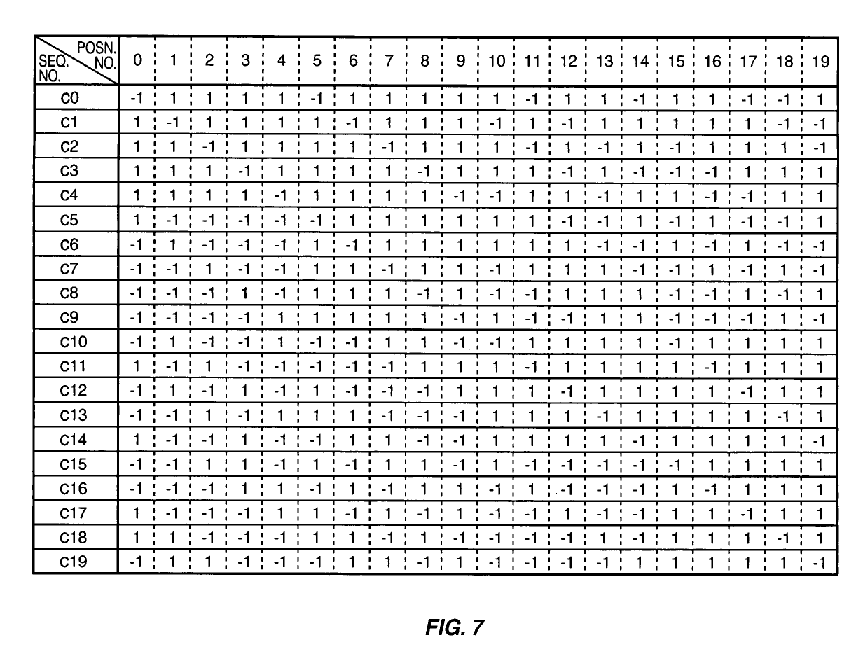

FIG. 7 illustrates one exemplary Williamson matrix resulting from Equation (5). As illustrated by FIG. 7, the set of sequences generated according to Equation (5) has a maximum column sum of 6 (bit positions 5-9 and 15-19).

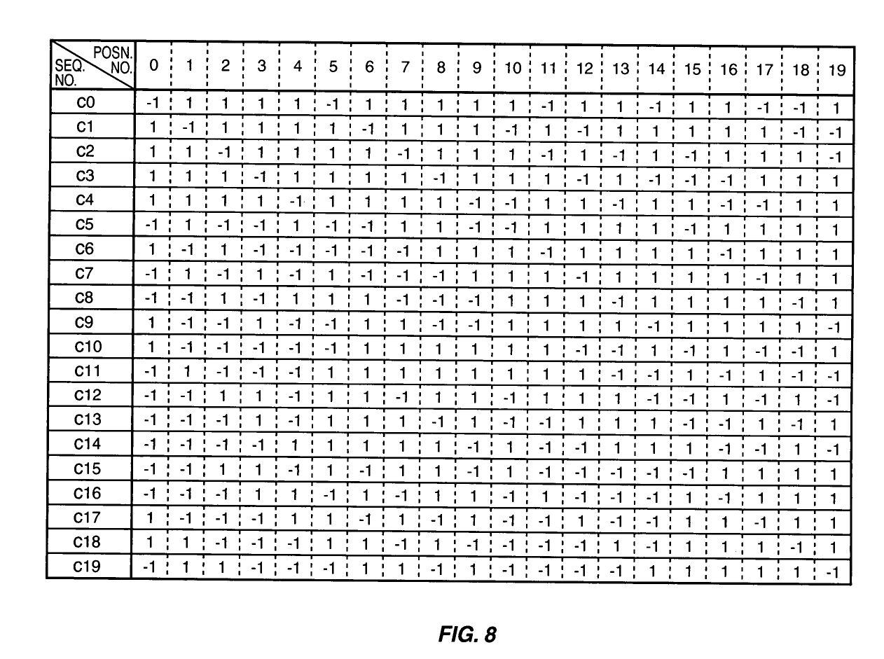

It will be appreciated that matrices A, C, and D may be combined in other ways to produce a desirable set of bit-level spreading sequences that satisfy the Williamson matrix requirements. For example, Equation (6) may be used to generate the set of bit-level spreading sequences shown in FIG. 8.

$$S = [ \begin{matrix}A & A & C & D \\ - C & - D & A & A \\ - A & A & D & - C \\ - D & C & - A & A\end{matrix} ] \qquad ( 6 )$$

As illustrated by FIG. 8, this set of bit-level spreading sequences also has a maximum column sum of 6 (bit positions 5-9 and 15-19).

According to yet another exemplary embodiment, controller 6 may randomly apply a mask as part of the code multiplexing process. For example, controller 6 may apply a mask to one or more E-HICH and/or E-RGCH symbols. The mask may be defined by a mobile terminal identity number and/or by a system slot number (or TTI number). For example, when the mask is 1, E-RGCH may use “1” to signal the “up” command and “−1” to signal the “down” command. When the mask is −1, E-RGCH may use “1” to signal the “down” command and “−1” to signal the “up” command. A similar masking technique can also be employed on the E-HICH. While not explicitly discussed herein, it will be appreciated that the base station provides the effected mobile terminal(s) with information regarding the mask so that the mobile terminal(s) can properly decode the control commands. According to this embodiment, even when the stored set of bit-level spreading sequences includes a large number of “1” or “−1” code values in a particular bit position, the masking embodiment reduces the likelihood of a high peak power by forcing a portion of the mobile terminals to use “−1” to represent the same command typically reserved for the “1” code value.

Alternatively, controller 6 may apply a mask to randomly selected ones of the bit-level spreading sequences stored in memory 8. This mask complements the code values in the selected bit-level spreading sequences. Unlike the first embodiment described above, this embodiment requires controller 6 to perform the complementing process on stored bit-level spreading sequences before assigning the bit-level spreading sequences to particular mobile terminals. As such, according to this embodiment, controller 6 periodically modifies a randomly selected sub-set of bit-level spreading sequences stored in memory 8 in real time to generate the specially configured set.

Regardless of whether the reduced-peak power sequence set is generated in advance and stored in memory 8 or generated in real-time, controller 6 selects a bit-level spreading sequence from the sequence set for each mobile terminal. The bit-level code multiplexer 2 then generates the combined E-HICH signal and/or E-RGCH signal using the selected bit-level spreading sequences as discussed above with reference to FIGS. 2 and 3. When only a portion of the available set of bit-level spreading sequences is being used, controller 6 may intelligently select bit-level spreading sequences from the sequence set to ensure that no one bit-position in the selected bit-level spreading sequences has all the same code values.

While the above three embodiments help reduce the likelihood of having a high peak power, the peak power may still be high if the output of the bit-level spreaders 12 has the same value in one or more bit positions for all of the individual spread symbols. Statistically, this does not occur very often. For example, this may statistically occur only once every 35 seconds when messages have to be sent every 2 ms. However, to prevent this statistical phenomenon from resulting in an excessively high peak power, controller 6 may apply a hard limit to one or more values in the combined E-HICH signal 26 and/or the combined E-RGCH signal 28 to prevent the power in any one bit position from exceeding a predefined value. For example, if any one bit position in the combined signal 26, 28 has a value that exceeds a predetermined limit, such as 15, controller 6 may replace that value with a different predetermined value, such as 15. While not explicitly shown, this hard limit may be applied at any point after the bit-level multiplexer 2, including at output signals 32, 36 and at any combination of the output signals 32, 36.

The hard limit may cause a loss of orthogonality amongst the spread E-HICH and/or E-RGCH signals. As a result, near-end mobile terminals may experience interference from signals addressed to far-end mobile terminals. However, in anticipation of this problem, the base station may pre-compensate the near-end mobile terminal to give it more power. The problem may also be addressed by providing each mobile terminal with receiver algorithms that are robust against such interference.

The above discusses the present invention in terms of length-20 bit-level spreading sequences, where each sequence includes 20 real code values. However, the present invention is not so limited. As will be appreciated by those skilled in the art, the present invention applies equally well to sequences with different lengths. For example, a subset of a pre-defined set of bit-level spreading sequences may be complemented (in advance or randomly in real time) regardless of the size of the set. In another example, as shown by Equation (7), the Williamson matrix S described above may be used to generate a 40×40 matrix Q representing 40 sequences, each having 40 code values.

$$Q = [ \begin{matrix}K & K \\ K & - K\end{matrix} ] \qquad ( 7 )$$

Alternatively, Q may be defined by:

$$Q = [ \begin{matrix}K & 0 \\ 0 & - K\end{matrix} ] . \qquad ( 8 )$$

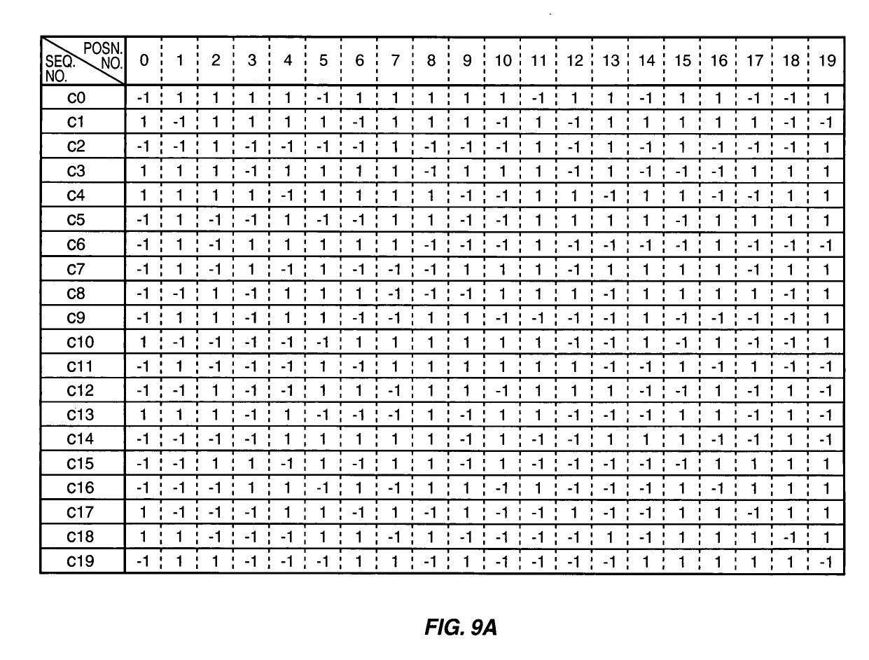

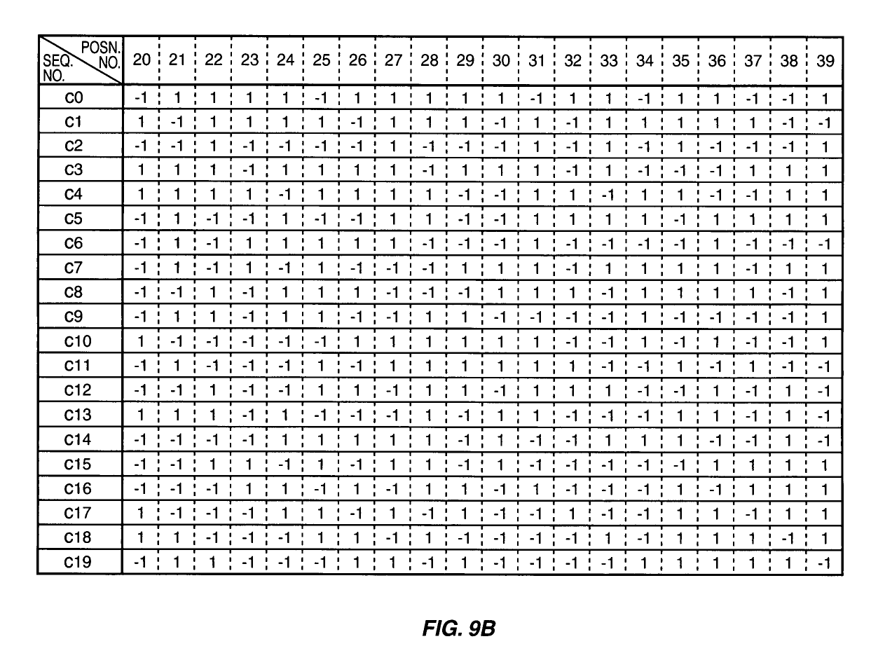

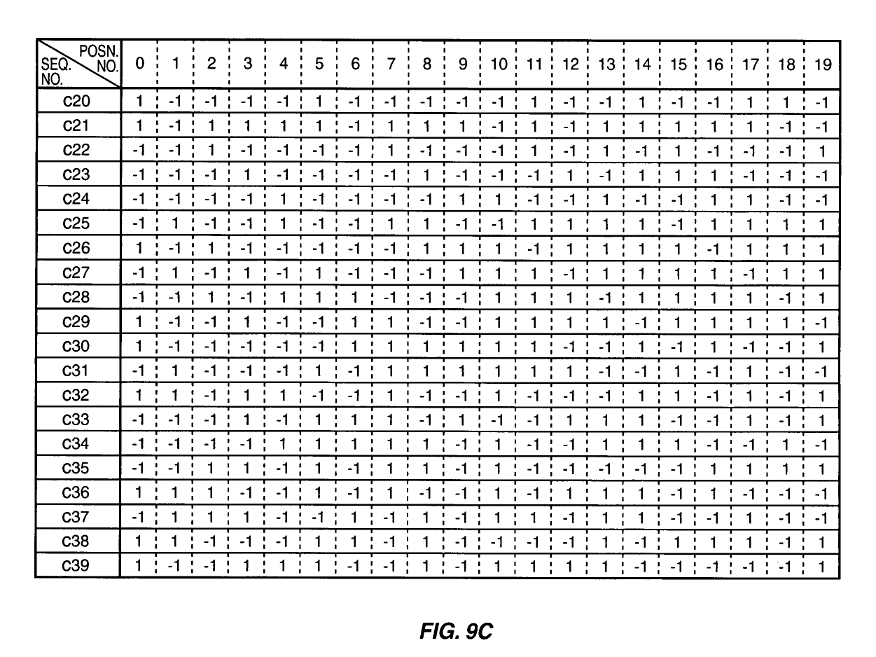

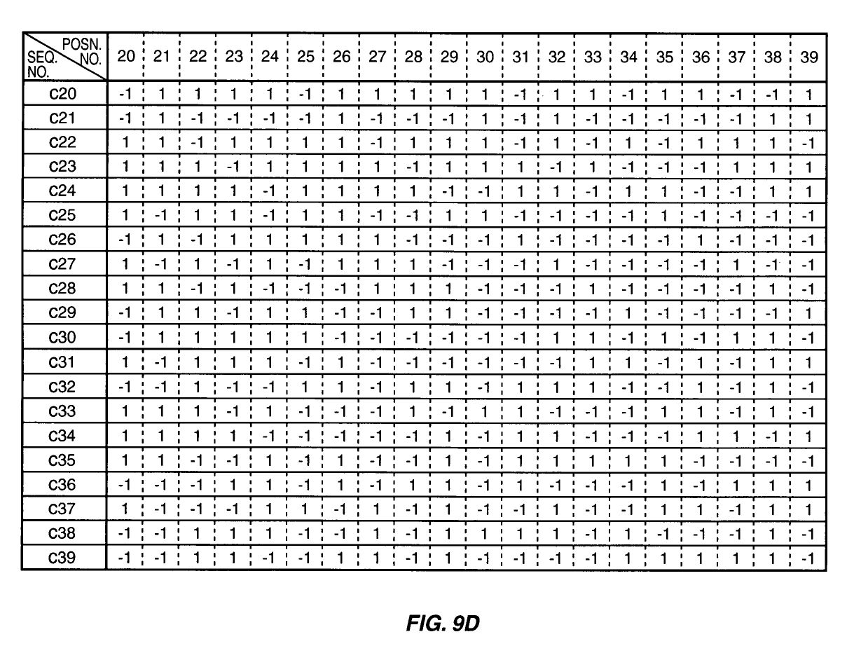

In still another embodiment, Q may be defined by complementing the code values in rows 3, 7, 10, 14, 21, 23, 24, 25, 33, 37, 38, and 40 of the matrix defined by Equation (7). FIGS. 9A-9D illustrate the resulting matrix of 40 orthogonal bit-level spreading sequences, each having 40 code values.

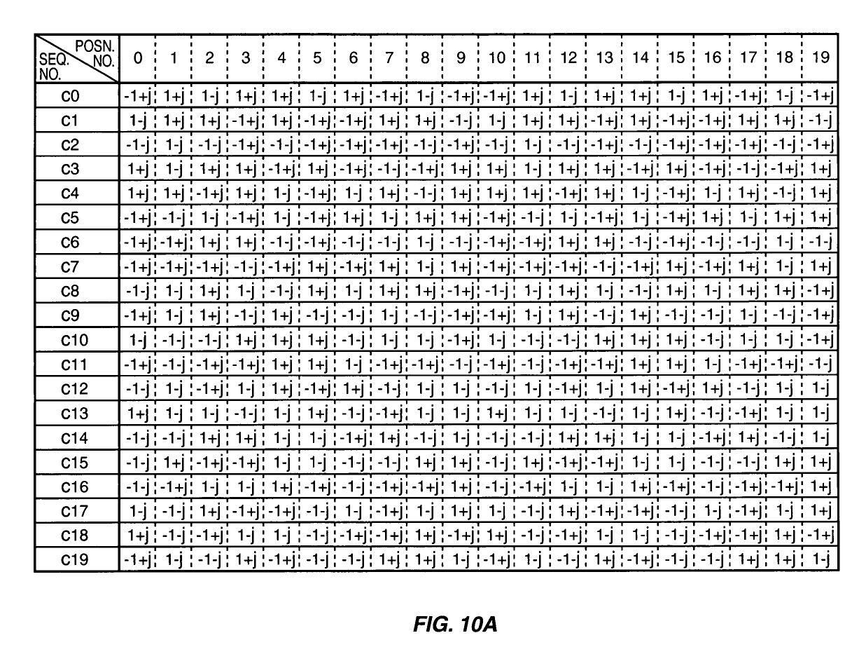

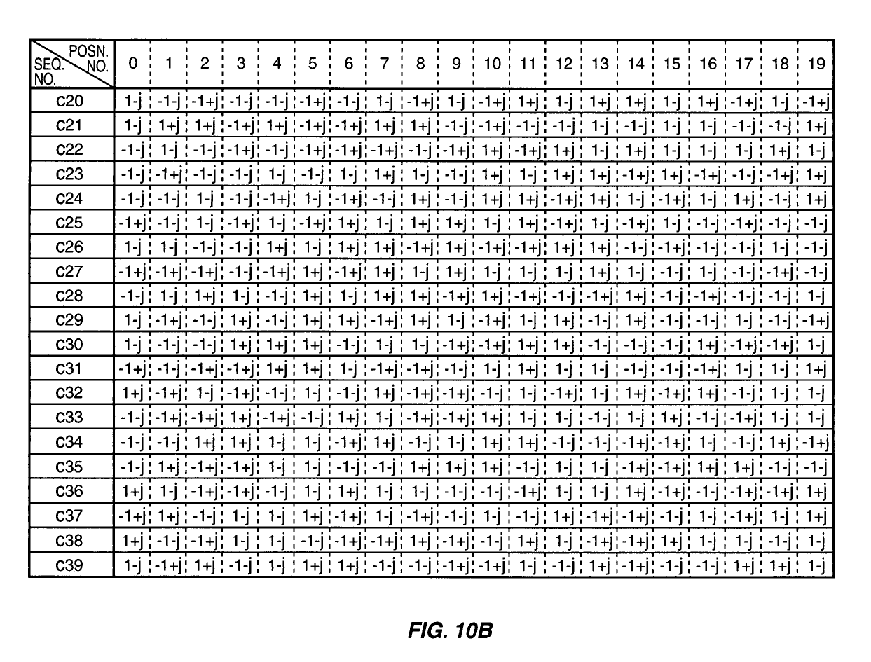

Further, a length-20 set of complex orthogonal spreading sequences may be obtained by mapping the even and odd columns to the real and imaginary parts of QPSK symbols, where the first column is labeled as column “0.” FIGS. 10A-10B illustrate the resulting matrix of 20 complex orthogonal bit-level spreading sequences, each having 20 complex code values. In this example, each column sum has the same magnitude. Therefore, this exemplary set of complex orthogonal bit-level spreading sequences achieves a peak-to-average ratio (PAR) of 1.

In addition to helping reduce the peak power, the sequence set(s) discussed above may provide additional processing and/or memory benefits. For example, a set of orthogonal bit-level spreading sequences based on a Williamson matrix provide additional novel benefits, such as memory savings and demodulation benefits. First, because the Williamson matrices generated according to Equations (5) and (6) contain cyclic shifts and their repeats of the two short sequences a and c, the memory requirements for storing S are substantially reduced at both the transmitter and the receiver.

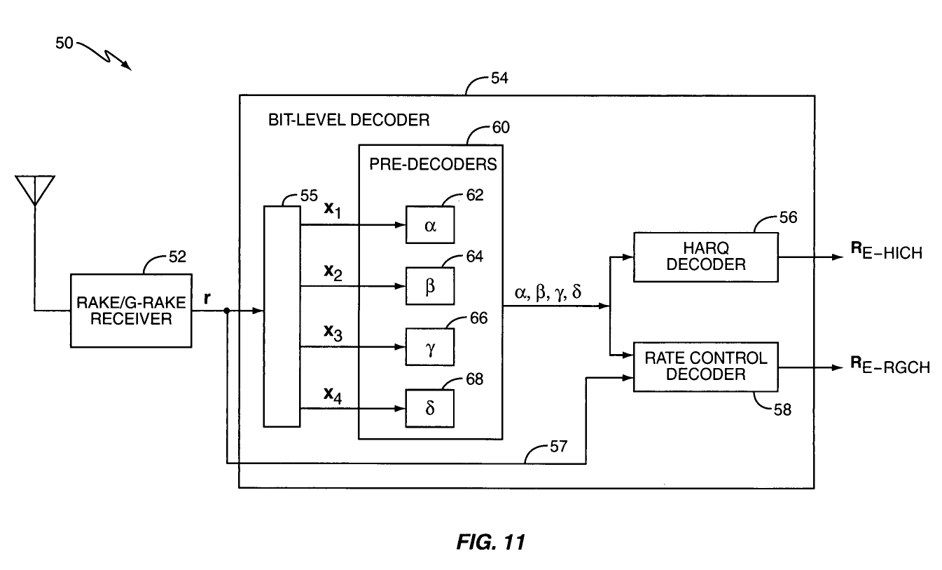

In addition, the modular structure of the Williamson matrices may be exploited to reduce receiver complexity. FIG. 11 illustrates an exemplary wireless receiver 50 for receiving the code multiplexed signals discussed above. Receiver 50 includes a multi-path receiver, such as a RAKE or a G-RAKE receiver 52, and a bit-level decoder 54. RAKE/G-RAKE receiver 52 despreads a received signal using a corresponding channelization code to generate a RAKE output signal. In the exemplary embodiment shown in FIG. 11, the same channelization code is used for both the E-HICH and E-RGCH. The RAKE output signal comprises a vector of received symbols r, where r={r₀, r₁, r₂, . . . , r_{N}} are the despread values output from the RAKE-GRAKE receiver 52, and N represents the spreading factor. Bit-level decoder 54 includes a serial-to-parallel converter 55, a set of pre-decoders 60, a HARQ decoder 56, and a rate control decoder 58. Serial-to-parallel converter 55 separates the received vector into m equal-sized subset vectors x₁, x₂, x₃, and x₄. The set of pre-decoders 60 generates intermediate decoded values α, β, γ, δ by decoding the subset vectors of the received vector r. HARQ decoder 56 and rate control decoder 58 use the intermediate decoded values to recover the R_{E-HICH} and R_{E-RGCH} symbols. To better understand this process, the following first provides some background.

Assume that x represents a length-5 subset of the vector of received symbols. Based on this assumption, serial-to-parallel converter 55 may separate the vector of received symbols r into multiple subset vectors, such as the four equal-length subset vectors:
x₁{r₀, r₁, r₂, r₃, r₄}
x₂={r₅, r₆, r₇, r₈, r₉}
x₃={r₁₀, r₁₁, r₁₂, r₁₃, r₁₄}
x₄={r₁₅, r₁₆, r₁₇, r₁₈, r₁₉}, (9)
and that Dx is defined by:
Dx=2x−Cx (10)
In addition, assume that controller 6 assigns a matched pair of sequences, i.e., sequence number i for the E-HICH and sequence number (i+10) for the E-RGCH of a particular mobile terminal. As used herein, the term “matched pair” refers to an inter-related pair of sequences in a set of bit-level spreading sequences. Under these assumptions, HARQ decoder 56 and rate control decoder 58 may recover the symbol for the E-RGCH using intermediate values α, β, γ, and δ computed by the set pre-decoders 60. More particularly, alpha decoder 62 generates the intermediate value α as a function of the received symbols in subset vector x₁. Similarly, beta decoder 64, gamma decoder 66, and delta decoder 68 generate the intermediate values β, γ, and δ, respectively, as a function of the received symbols in subset vectors x₂, x₃, and x₄, respectively. Equation (11) illustrates the relationship between the intermediate values and the vector of received symbols r when the matched pair of sequences comprises sequences i and i+10 selected from the sequence set illustrated in FIG. 8.
α=−r₀+r₁+r₂+r₃+r₄
β=−r₅+r₆+r₇+r₈+r₉, (11)
γ=r₁₀−r₁₁+r₁₂+r₁₃−r₁₄
δ=r₁₅+r₁₆−r₁₇−r₁₈+r₁₉
Based on these intermediate values, HARQ decoder 56 may recover the E-HICH symbol (R_{E-HICH}) according to:
R_{E-HICH}=α+β+γ+δ, (12)
and rate control decoder 58 may recover the E-RGCH symbol (R_{E-RGCH}) according to:
R_{E-RGCH}=α+β−γ+δ+2(r₁₀−r₁₅), (13)
where line 57 in FIG. 11 provides the additional symbols r₁₀−r₁₅ from the vector of received symbols r. While not explicitly shown, those skilled in the art will appreciate that either HARQ decoder 56 or rate control decoder 58 may include the set of pre-decoders 60. According to this embodiment, the decoder 56, 58 that includes the set of pre-decoders 60 not only outputs the appropriate decoded symbol, but also provides the intermediate values to the other decoder 58, 56.

Those skilled in the art will appreciate that different intermediate values and decoding functions may be generated for different sequence sets that are based on or derived from different Williamson matrices. Further still, while the above is described relative to HARQ and rate control channel symbols, this same property holds for other control channel symbols encoded using a matched pair of bit-level spreading sequences selected from a sequence set based on or derived from a Williamson matrix.

The above describes the invention in terms of multiple E-HICH and E-RGCH symbols. However, those skilled in the art will appreciate that the present invention is not so limited. The present invention is applicable to any code multiplexer that uses multiple spreading sequences to multiplex like bits, symbols, or signals for multiple mobile terminals.

While each of the above embodiments were discussed separately, it will be appreciated by those skilled in the art that one or more of these embodiments may be combined to generate other sets of orthogonal bit-level spreading sequences. For example, one or more rows of an exemplary Williamson matrix may be complemented, swapped, or otherwise modified as discussed above without altering the orthogonality of the resulting set of bit-level spreading sequences. Further, one or more columns of an exemplary Williamson matrix may be swapped without altering the orthogonality of the resulting set of bit-level spreading sequences. The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

We claim:

1. A method of code multiplexing downlink control channel symbols for a plurality of mobile terminals, the method comprising:
selecting a different bit-level spreading sequence for each one of the mobile terminals from a set of orthogonal bit-level spreading sequences, wherein code values in any one bit position are not the same for all bit-level spreading sequences in said set;
spreading said downlink control channel symbols for said mobile stations with corresponding bit-level spreading sequences to generate multiple spread control channel symbols; and
combining said multiple spread control channel symbols to generate a combined signal.

2. The method of claim 1 wherein the set of bit-level spreading sequences comprises a predefined set of bit-level spreading sequences generated by:
complementing all code values in a subset of an initial set of bit-level spreading sequences to generate a modified set of bit-level spreading sequences; and
storing the modified set of bit-level spreading sequences in memory as the predefined set of bit-level spreading sequences.

3. The method of claim 1 wherein the set of bit-level spreading sequences comprises a periodically generated set of bit-level spreading sequences generated by complementing the code values of a randomly selected subset of a predefined set of bit-level spreading sequences.

4. The method of claim 1 wherein the set of orthogonal bit-level spreading sequences comprises a set based on or derived from a Williamson matrix.

5. The method of claim 1 wherein selecting a different bit-level spreading sequence for each one of the mobile terminals comprises selecting a matched pair of bit-level spreading sequences from the set of orthogonal bit-level spreading sequences for two of said mobile terminals.

6. The method of claim 5 wherein the set of orthogonal bit-level spreading sequences comprises a set based on or derived from a Williamson matrix.

7. The method of claim 5 wherein the matched pair comprises a pair of bit-level spreading sequences that allow decoding a received sequence of values corresponding to two of said mobile terminals using intermediate values computed based on one or more subsets of the received sequence of values.

8. The method of claim 1 wherein summing code values in any one bit position of said set produces a sum that does not exceed n/2, where n represents the number of orthogonal bit-level spreading sequences in the set.

9. The method of claim 1 wherein summing code values in each bit position of said set produces an identical sum for each bit position.

10. The method of claim 1 wherein code values in any one bit position of the selected bit-level spreading sequences are not the same for all bit-level spreading sequences in the selected set.

11. The method of claim 1 further comprising spreading the combined signal using a common channelization code.

12. The method of claim 1 further comprising hard limiting the combined signal at a pre-defined level.

13. The method of claim 1 wherein values in any one bit position of said multiple spread control channel symbols are not the same for all spread control channel symbols.

14. A code multiplexer for code multiplexing downlink control channel symbols for a plurality of mobile terminals, the multiplexer comprising:
a controller configured to select a different bit-level spreading sequence for each one of the mobile terminals from a set of orthogonal bit-level spreading sequences, wherein code values in any one bit position are not the same for all bit-level spreading sequences in said set;
a plurality of multipliers configured to spread said downlink control channel symbols for said mobile terminals with corresponding bit-level spreading sequences to generate multiple spread control channel symbols; and
a combiner configured to combine the multiple spread control channel symbols into a combined signal.

15. The multiplexer of claim 14 wherein the set of bit-level spreading sequences comprises a predefined set of bit-level spreading sequences generated by:
complementing all code values in a subset of an initial set of bit-level spreading sequences to generate a modified set of bit-level spreading sequences; and
storing the modified set of bit-level spreading sequences in memory as the predefined set of bit-level spreading sequences.

16. The multiplexer of claim 14 further comprising memory configured to store a predefined set of normalized bit-level spreading sequences, wherein the controller is further configured to complement the code values of a randomly selected subset of the set of bit-level spreading sequences before selecting the bit-level spreading sequences for each mobile terminal.

17. The multiplexer of claim 14 wherein the set of orthogonal bit-level spreading sequences comprises a set based on or derived from a Williamson matrix.

18. The multiplexer of claim 14 wherein the controller is configured to select a matched pair of bit-level spreading sequences from the set of orthogonal bit-level spreading sequences for two of said mobile terminals.

19. The multiplexer of claim 18 wherein the set of orthogonal bit-level spreading sequences comprises a set based on or derived from a Williamson matrix.

20. The multiplexer of claim 14 wherein a sum of all code values in any one bit position of said set does not exceed n/2, where n represents the number of orthogonal bit-level spreading sequences in the set.

21. The multiplexer of claim 14 wherein a sum of all code values in each bit position of said set produces an identical sum for each bit position.

22. The multiplexer of claim 14 wherein code values in any one bit position of the selected bit-level spreading sequences are not the same for all bit-level spreading sequences in the selected set.

23. The multiplexer of claim 14 further comprising a channel spreader configured to spread the combined signal using a common channelization code.

24. The multiplexer of claim 14 wherein the controller further hard limits the combined signal to at or less than a predefined value.

25. The multiplexer of claim 14 wherein values in any one bit position of said multiple spread control channel symbols are not the same for all spread control channel symbols.

26. A method of code multiplexing downlink control channel symbols for a plurality of mobile terminals, the method comprising:
complementing code values in randomly selected bit-level spreading sequences of a pre-defined set of bit-level spreading sequences to randomly generate a set of orthogonal bit-level spreading sequences, wherein code values in any one bit position are not the same for all bit-level spreading sequences in said randomly generated set;
selecting a different bit-level spreading sequence for each one of the mobile terminals from the randomly generated set of orthogonal bit-level spreading sequences; and
spreading said downlink control channel symbols for said mobile terminals with corresponding bit-level spreading sequences to generate multiple spread control channel symbols, and
combining the multiple spread control channel symbols to generate a combined signal.

27. A method of recovering one or more downlink control channel symbols from a vector of received symbols received at a receiver from a transmitter, said vector of received symbols code multiplexed at the transmitter using a matched pair of bit-level spreading sequences, the method comprising:
separating the vector of received symbols into one or more subset vectors;
generating one or more intermediate values, wherein each intermediate value is a function of a different subset vector; and
decoding the vector of received symbols based on the one or more intermediate values to recover the one or more downlink control channel symbols.

28. The method of claim 27 wherein the matched pair of bit-level spreading sequences comprises a matched pair from a set of bit-level spreading sequences based on or derived from a Williamson matrix.

29. The method of claim 27 further comprising despreading a received signal using a channelization code corresponding to the receiver to generate the vector of received symbols.

30. A bit-level decoder for recovering one or more downlink control channel symbols from a vector of received symbols received at a receiver from a transmitter, said vector of received symbols code multiplexed at the transmitter using a pair of matched bit-level spreading sequences, the decoder comprising:
a serial-to-parallel converter configured to separate the vector of received symbols into one or more subset vectors;
one or more pre-decoder circuits configured to generate one or more intermediate values, wherein each intermediate value is a function of a different subset vector; and
one or more decoder circuits configured to decode the vector of received symbols based on the one or more intermediate values to recover the one or more downlink control channel symbols.

31. The bit-level decoder of claim 30 wherein the matched pair of bit-level spreading sequences comprises a matched pair from a set of bit-level spreading sequences based on or derived from a Williamson matrix.

32. The bit-level decoder of claim 30 further comprising a multi-path receiver configured to despread a received signal using a channelization code corresponding to the receiver to generate the vector of received symbols.
